(19) United States
(12) Patent Application Publication
(10) Pub. No.: US 2026/0356335 A1
(43) Pub. Date: Nov. 12, 2026

(54) BRAKE SYSTEM FOR A VEHICLE

(71) Applicant: ZF CV Systems Global GmbH, Bern (CH)

(72) Inventors: Jan Cohrs, Hannover (DE); Peter Beier, Wunstorf (DE); Christoph Moritz, Hannover (DE); Julian Van Thiel, Grossburgwedel (DE)

(21) Appl. No.: 19/135,206

(22) PCT Filed: Nov. 6, 2023
(86) PCT No.: PCT/EP2023/080786

§ 371 Date: Jun. 3, 2025

(30) Foreign Application Priority Data
Dec. 5, 2022 (DE) 10 2022 132 229.7

(51) Int. Cl. B60T 8/26; B60T 8/172; B60T 13/74; B60T 17/22

(52) U.S. Cl. CPC B60T 8/26; B60T 8/172; B60T 13/746; B60T 17/22

(57) ABSTRACT

A brake system (1) for a vehicle (100), in particular for a utility vehicle, having a plurality of electromechanical brakes (5) controls the electromechanical brakes (5) such that actuation processes for executing a parking brake function (B_{P}), a service brake function (B_{B}), and an emergency brake function (B_{N}) are executed by the system. A dedicated electrical energy storage subsystem (9) for the brake system (1) connects to an on-board power supply system (200) of the vehicle (100), and stores a reserve charge (q_{R}) for at least one final actuation process for the execution of the emergency brake function (B_{N}).

### FIELD

The present disclosure relates to a brake system for a vehicle, in particular for a utility vehicle, having a plurality of electromechanical brakes for braking the vehicle, which brake system is designed to control the electromechanical brakes such that actuation processes for executing a parking brake function, a service brake function and an emergency brake function are executed by the system.

### BACKGROUND

Brake systems which are embodied in the above-mentioned manner are generally known. In the event of an emergency actuation of a brake system, the tensioned spring within a spring mechanism of a brake cylinder is released such that, by the spatial expansion thereof, pressure is applied to the closing mechanism of a brake, and the brake is thus actuated and engaged. By way of this emergency actuation (hereinafter: emergency brake function), a protective system is integrated in vehicles accordingly.

However, the springs of spring mechanisms which are tensioned for the execution of the emergency brake function are exposed to high pressures. As a result, the installation and maintenance of such spring mechanisms represent a hazard to the person responsible for the execution of installation or maintenance. Corresponding, and occasionally cost-intensive safety measures, are required accordingly.

In the context of expanding electrification, the significance and employment of electromechanical brakes in utility vehicles is increasing. Electromechanical brakes provide an advantage, in that they are actuated electrically, rather than pneumatically, which electrical actuation, vis-à-vis pneumatic systems, inter alia, can provide installation advantages.

A precondition for the employment of electromechanical brakes is that a sufficient charging energy for the actuation thereof is maintained at all times. A collapse of the power supply employed for this purpose represents a potential hazard for the operation of these brakes. In addition to the quantity of charge or energy, the maintenance of which is absolutely necessary, it is also a precondition that the instantaneous power required can be delivered by the energy store. In an apparently “empty” battery, this is not generally the case, in that the voltage is sometimes reduced to the extent that the battery is no longer capable of outputting sufficient power.

### SUMMARY

The object of the present disclosure is the provision of an improved safety architecture for a braking system of the above-mentioned type which overcomes the above-mentioned disadvantage. In particular, the object of the present disclosure is the disclosure of a brake system which, independently of the state of the on-board power supply system, enables the maintenance of the most important brake functions, in particular at least the emergency brake function.

In a brake system of the above-mentioned type, it is provided, according to the present disclosure, that the brake system includes a dedicated electrical energy storage subsystem which is designed to be connected to an on-board power supply system of the vehicle, and which is designed to store a reserve charge for at least one final actuation process for the execution of the emergency brake function in the brake system.

The present disclosure is based upon the finding to the effect that the requisite energy for the actuation and engagement of brakes, for the purposes of the execution of an emergency brake function, can be stored in an electrical form. To this end, it is proposed that a separate energy storage subsystem is integrated in the vehicle such that, independently of the primary battery or of the on-board power supply system of the vehicle, at the time of an emergency braking operation, sufficient energy is available for the latter. Because it is necessary for this energy, for the guaranteed execution of an emergency brake function, to be available in the energy storage subsystem at all times, this energy is described, heretofore and hereinafter, as a reserve charge.

In this context, “charge” is to be understood as a synonym for “energy”, as an available charge, which describes the separation of positive and negative charge carriers, can be employed for the execution of work. The term “reserve charge” is thus to be understood as a predetermined quantity of energy which, at a predetermined power, can be output from energy stores for the actuation and engagement of brakes. Given that, as described above, the simple maintenance of a quantity of charge does not, in itself, guarantee that an output thereof can be executed, even in the event of a sufficient power, the term “reserve charge” within the meaning of the invention, is understood as an association of the quantity of charge and a performance capability. By the integration of an energy storage subsystem in the brake system, one or more energy stores are provided which can continue to deliver the reserve charge, even in the event of the occurrence of problems in the energy supply, for example faults such as short-circuits, in the on-board power supply system, i.e. in the primary voltage supply of the utility vehicle. The robustness of the utility vehicle in general, and of the brake system in particular, vis-à-vis electrical malfunctions is thus improved.

In the context of the present disclosure, any preceding and subsequent reference to energy stores is respectively to be understood as a reference to an electrical energy store.

An advantageous further development of the present disclosure is provided, where the energy storage subsystem includes one or more electrical energy stores, each of which partially or entirely carries the reserve charge. An architecture having a singular energy store is advantageous with respect to resources and effective servicing. An architecture having multiple energy stores provides advantages with respect to the flexibility of structural layout, and enables the reserve charge to be supplied in the event of the partial loss of one of more energy stores, by way of the still intact further energy stores, in the interests of the minimization of risk.

In a preferred embodiment of the present disclosure, at least one electrical energy store is assigned to a front axle and/or to a rear axle, further preferably to each axle, of the vehicle.

Alternatively or additionally, a (further) electrical energy store is assigned to at least one, to a number, or to all of the electromechanical brakes, and is preferably integrated in the electromechanical brake in each case.

Further preferably, the energy storage subsystem comprises at least one superordinate electrical energy store.

Accordingly, preferred embodiments also include an energy storage subsystem having multiple energy stores, namely, n energy stores which are respectively assigned to one axle, and/or m energy stores which are respectively assigned to one electromechanical brake, and/or p superordinate energy stores, wherein n, m and p are natural numbers in each case.

In a preferred embodiment of the present disclosure, the energy storage subsystem is designed, additionally to the reserve charge, to deliver additional electrical energy for the service brake function and/or for other ancillary loads. As a result, a load relief of the primary battery or of the on-board power supply system of the vehicle is enabled, and dependence upon one or fewer central energy stores is reduced. In preferred embodiments, by way of an ancillary load, for example, a steering system according to Regulation no 79 of the United Nations Economic Commission for Europe (UNECE)—Uniform provisions concerning the approval of vehicles with regard to steering equipment”, published in the Official Journal L318/1 on 14.12.2018, is provided.

In a preferred embodiment of the present disclosure, the brake system includes a brake control subsystem, having a superordinate control module and at least one control unit for each axle of the vehicle, and the brake control subsystem is designed to transmit signals for the actuation of electromechanical brakes to the control units for each axle. In each case, the control units are functionally assigned to one or more axles, and are simultaneously topologically independent thereof; therefore, the control units are not necessarily fitted to one of the axles.

In a preferred embodiment of the present disclosure, the superordinate control module is designed to monitor the parking brake function of the brake system for normal operation and, in the event of a critical fault, to generate an emergency actuation signal. According to one variant, the control module can also be configured as a switch. As a superordinate functional unit, the control module is designed to control and/or monitor the parking brake function and/or the emergency brake function.

In a preferred embodiment of the present disclosure, the at least one control unit is designed to monitor the brake system for normal operation and, preferably, in the event of a critical fault, to generate an emergency actuation signal. Under normal circumstances, the control unit is moreover designed to control the brake system on the associated axle in the normal (no-fault) state thereof, in particular the service brake function of the brake system.

The superordinate control module and/or the control units are preferably designed to monitor the connection status of components of the brake system and/or various characteristic operating variables such as, for example, capacitance and/or an electric voltage, particularly in a manner which is independent of other systems. In this context, a critical fault is to be understood as an operating state which, if neglected, might preclude the guarantee of a final actuation of electromechanical brakes, for example on the grounds of an insufficient charge in energy stores, or as a result of damaged conductors.

In a preferred embodiment of the present disclosure, the superordinate control module is integrated in a parking brake control device for the parking brake function, or is controlled from outside of the parking brake control device.

In a preferred embodiment of the present disclosure, the brake system includes a locking mechanism, having a locking position and a release position, which is designed to maintain the electromechanical brakes in a locked position, upon the achievement of a target clamping force, or in the event of an undershoot of a critical quantity of energy in the electrical energy storage subsystem. In the locking position of the locking mechanism, the brake mechanism within the electromechanical brakes is blocked in the locked position, such that the brakes can no longer be released. In the release position, conversely, the brakes are operable, and the employment of the service brake function is possible.

In a preferred embodiment of the present disclosure, the electromechanical brakes respectively include an electrical control module and a motor control unit.

In a preferred embodiment of the present disclosure, the respective electrical control module is designed to receive the emergency actuation signal, and the motor control unit is designed to convert the emergency actuation signal (which is processed by the respective electrical control module), by way of the reserve charge, into a mechanical motion within the electromechanical brake, by way of which a clamping force acting on the respective wheel is generated.

The electrical control module of the electromechanical brake is preferably designed to control the braking force of the brake, in communication with the superordinate control module and/or the control units.

The motor control unit controls the motor of the electromechanical brake, and thus supplies the latter with three-phase current, controls the rotational speed, or similar. The electrical control unit of the electromechanical brake communicates with system components which are external to the electromechanical brake. The motor control unit and the electrical control unit of the electromechanical brake can be structurally consolidated.

In a preferred embodiment of the present disclosure, the electrical control modules of the electromechanical brakes are designed, in the event of the detection of a critical system state, to execute the emergency brake function. In this context, a critical system state is to be understood as a state in which a failure of the energy store which is assigned to the electromechanical brake, or of the energy store which is assigned to the respective axle, a failure of the electrical control module and/or of the motor control unit of an electromechanical brake, or a wheel failure, is impending or is in force. The electromechanical brakes communicate with one another, or communicate via the superordinate control module or the control units of the brake control subsystem.

The above-mentioned arrangement is described heretofore with respect to a first aspect. According to a further aspect, the present disclosure relates to a vehicle, in particular to a utility vehicle, having an on-board power supply system and a brake system which is connected to the on-board power supply system.

According to the present disclosure, the above-mentioned object is fulfilled by a vehicle of this type, wherein the brake system is configured according to one of the above-mentioned preferred embodiments. In particular, the vehicle includes a brake controller, having one or more control devices, which are configured as separate control devices or are hardware- or software-integrated. In particular, the brake controller includes a service brake and a parking brake control device.

In preferred embodiments, the vehicle includes a superordinate vehicle control system, which is connected to the control devices or modules in a signal-conducting arrangement, and which is designed to transmit control commands, or in which the above-mentioned control devices or modules are integrated. Moreover, in preferred embodiments, commands for executing the parking brake function, the service brake function and/or the emergency brake function can be generated by a driver or by a (partially) autonomous vehicle control system, also described as a “virtual driver”.

The present disclosure appropriates the same advantages according to the second aspect as those appropriated by the brake system according to the first aspect.

Preferred embodiments of the first aspect are simultaneously preferred embodiments of the second aspect, and vice versa, such that, for the avoidance of repetitions, reference may be made to preceding explanations.

According to a further aspect, the present disclosure relates to a method for controlling a brake system of a vehicle, in particular of a utility vehicle.

The present disclosure fulfils the above-mentioned object by way of a method of this type, particularly by the employment of a brake system according to one of the above-mentioned preferred embodiments.

In particular, the method according to the present disclosure includes the following steps:
Control of multiple electromechanical brakes such that actuation processes for the execution of a parking brake function, a service brake function and/or an emergency brake function are executed; and
Storage of a reserve charge for at least one final actuation process for the execution of the emergency brake function in the brake system, in a dedicated energy storage subsystem of the brake system.

The method appropriates the same advantages as the brake system according to the first aspect and the vehicle according to the second aspect. Preferred embodiments of the first two aspects are simultaneously preferred embodiments of the method, and vice versa, such that, with respect hereto, in turn, for the avoidance of repetitions, reference may be made to the preceding explanations.

In a preferred embodiment of the method according to the present disclosure, the actuation process for executing the emergency brake function employs the reserve charge.

In a further preferred embodiment of the method according to the present disclosure, the method further comprises one, a number, or all of the following steps:
Provision, additionally to the reserve charge, of additional electrical energy for the service brake function and/or for other ancillary loads;
Transmission of signals for actuating the electromechanical brakes in response hereto, in particular by way of the brake control subsystem;
Monitoring of the parking brake function of the brake system for normal operation, and generation of an emergency actuation signal in the event of a critical fault, in particular by way of the superordinate control module;
Monitoring of the brake system for regulation operation, and generation of an emergency actuation signal in the event of a critical fault, in particular by way of the at least one control unit;
Control of the superordinate control module from outside of the parking brake control device;
Maintenance of the electromechanical brakes in the locked position, further to the achievement of a target clamping force or in the event of an undershoot of a critical quantity of energy in the electrical energy storage subsystem, in particular by way of the locking mechanism;
Reception of the emergency actuation signal by the respective electrical control module and conversion of the emergency actuation signal into a mechanical motion within the electromechanical brake by way of the reserve charge, in particular by way of the motor control unit; and/or
Execution of the emergency brake function by the electrical control modules of the electromechanical brakes.

### BRIEF DESCRIPTION OF THE DRAWINGS

The present disclosure is described in greater detail hereinafter, in consideration of the attached figures, with reference to preferred exemplary embodiments. In the figures:

FIG. 1 shows a schematic representation of the brake system according to a first preferred exemplary embodiment;

FIG. 2 shows a schematic representation of the brake system according to a second preferred exemplary embodiment;

FIG. 3 shows a schematic representation of the vehicle, comprising the brake system according to the second preferred exemplary embodiment.

### DETAILED DESCRIPTION

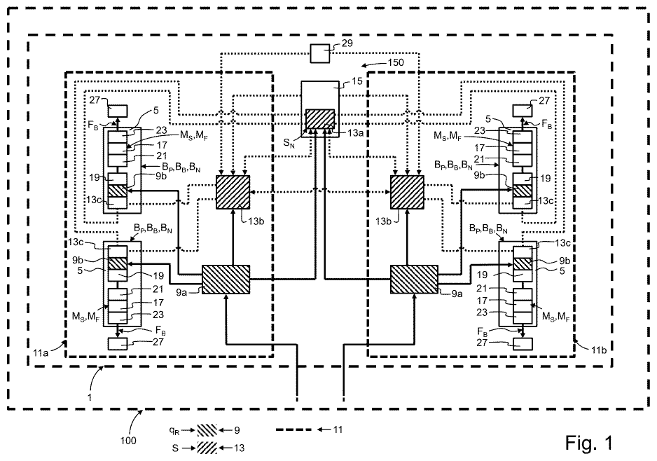

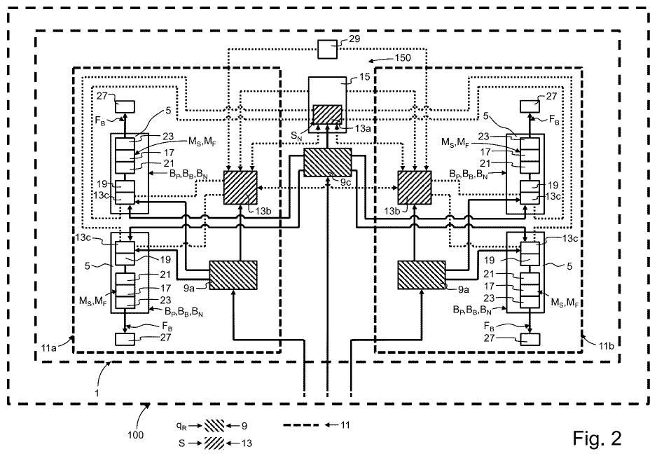

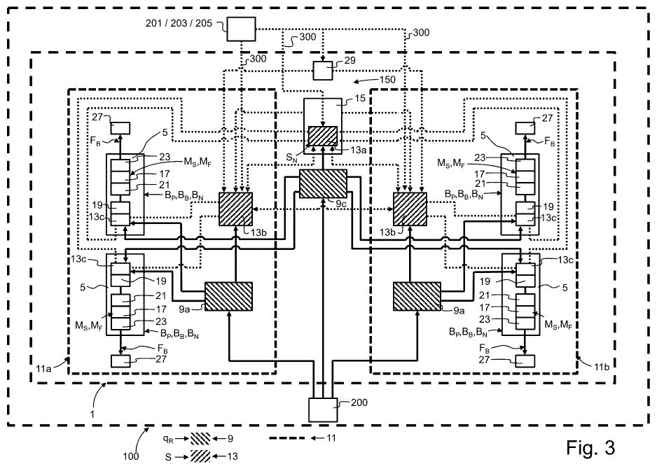

As described in greater detail hereinafter, the brake system represented in FIG. 2 illustrates a further development of the exemplary embodiment represented in FIG. 1. This brake system is both a manifestation of the exemplary embodiment according to FIG. 1, and a standalone exemplary embodiment. Consequently, elements having an identical structure and/or an identical are respectively identified in the figures by the same reference numbers. The same applies, in an analogous manner, to the exemplary embodiment represented in FIG. 3, which is a further development of the exemplary embodiment represented in FIG. 2.

FIG. 1 shows a brake system 1 for a vehicle 100, in particular for a utility vehicle. The brake system includes multiple electromechanical brakes 5 for braking the vehicle 100. The brake system 1 moreover includes a dedicated electrical energy storage subsystem 9. In the exemplary embodiment represented in FIG. 1, the energy storage subsystem 9 respectively includes one electrical energy store 9a for each of the axles 11 of the vehicle 100. The brake system 1 in the exemplary embodiment further includes a brake control subsystem 13, having a superordinate control module 13a and a control unit 13b for each axle 11 of the vehicle 100. The superordinate control module 13a is integrated in a parking brake control device 15 for the parking brake function B_{P}. In the exemplary embodiment, the electromechanical brakes 5 respectively include an electrical control module 13c, an electrical energy store 9b, a motor control unit 19, an electric motor 21, a locking mechanism 17, and a brake caliper 23. Additionally, the axles 11 in the exemplary embodiment respectively include two wheels 27. The brake system 1 moreover includes a service brake operating element 29, for example a brake switch or a brake pedal, for the service brake function B_{B}.

The superordinate control module 13a includes communication connections to the control units 13b and the electrical control modules 13c. The brake control subsystem 13 moreover includes a mutual communication connection between the control units 13b, communication connections between the control units 13b and the electrical control modules 13c, between the service brake control device 29 for the service brake function B_{B} and the control units 13b, and between the parking brake control device 15 for the parking brake function B_{P} and the control units 13b.

The energy storage subsystem 9 includes conductors for the transmission of energy or charge between the electrical energy store 9a and the electrical energy stores 9b of the electromechanical brakes 5. The electrical energy store 9a moreover includes conductors for the transmission of energy or charge to the control units 13b and to the superordinate control module 13a. As can be seen in FIG. 1, the energy storage subsystem 9 moreover includes energy- or charge-carrying conductors, which are infed from the exterior of the braking system 1 and connected to the electrical energy stores 9a. Additionally, these conductors can optionally be consolidated in a single wire harness.

During the operation of the braking system 1, the electromechanical brakes 5 are respectively designed to apply a braking force F_{B} to one of the wheels 27.

In the event of a critical fault, which is detected by the superordinate control module 13a, the brake system 1 is designed to generate an emergency actuation signal S_{N}, which is transmitted to the control units 13b and to the electrical control modules 13c of the electromechanical brakes 5. Thereafter, the reserve charge q_{R} of the energy store 9b of the electromechanical brakes 5 is employed for a final actuation process for the execution of the emergency brake function B_{N}.

In an analogous manner, in the event of a critical fault, an emergency actuation signal S_{N} can be generated by control unit 13b and transmitted to the superordinate control module 13a and to the electrical control modules 13c of the electromechanical brakes 5. Thereafter, the reserve charge q_{R} of the energy store 9b of the electromechanical brakes 5 is employed for a final actuation process for the execution of the emergency brake function B_{N}.

In the event of a detection of a critical system state by an electrical control module 13c within an electromechanical brake 5, in which a failure of the energy store 9b which is assigned to the electromechanical brake 5, or of the energy store 9a which is assigned to the respective axle 11, a failure of the electrical control module 13c and/or of the motor control unit 19 of an electromechanical brake 5, or a wheel failure, is impending or in force, the emergency brake function B_{N} is executed. The electromechanical brakes 5 communicate with one another, or via the superordinate control module 13a or the control units 13b of the brake control subsystem 13.

The exemplary embodiment represented in FIG. 2 illustrates a brake system 1 having an energy storage subsystem 9 which includes a superordinate energy store 9c having energy- or charge-carrying conductors which are routed to the electrical control modules 13c of the electromechanical brakes 5 and an energy- or charge-carrying conductor which is routed to the superordinate control module 13a. The energy stores 9b within the electromechanical brakes 5 which are illustrated in the exemplary embodiment according to FIG. 1 are not present in the exemplary embodiment according to FIG. 2. Moreover, in this case, the energy storage subsystem 9, on the respective axles 11, includes energy- or charge-carrying connections between the energy stores 9a and the electrical control modules 13c of the electromechanical brakes 5. Moreover, the energy storage subsystem 9 includes an additional energy- or charge-carrying conductor which is routed to the superordinate energy store 9c, and which is infed to the brake system 1 from the exterior.

FIG. 3 shows an exemplary embodiment having a vehicle 100 with an on-board power supply system 200 and a brake system 1 which is connected to the on-board power supply system 200, which embodiment is manifested according to FIG. 2, wherein the on-board power supply system 200 is connected to the energy stores 9a and 9c by way of energy- or charge-carrying conductors. In FIG. 3, moreover, a vehicle control system 201 is illustrated, which is designed to transmit control commands 300 to the brake control subsystem 13, in particular to the control module 13a, the control units 13b and/or the control modules 13c. As an alternative to the vehicle control system 201, a (partially) autonomous vehicle control system 203 or a driver 205 has a capability for the transmission of control commands.

It is to be understood, that the vehicle 100 can incorporate each of the brake systems 1 illustrated in FIG. 1 and in FIG. 2. Moreover, the schematic representations are not limited to these systems. Rather, these representations only illustrate examples of a multiplicity of potential combinations of the components of the brake system, particularly of the energy stores, which potential combinations are disclosed in the following claims.

### LIST OF REFERENCE SYMBOLS (INCLUDED IN THE DESCRIPTION)

1 Brake system
5 Electromechanical brakes
9 Energy storage subsystem
9a Electrical energy store, vehicle axle
9b Electrical energy store, brake
9c Superordinate electrical energy store
11 Axle (of the vehicle)
11a Front axle (of the vehicle)
11b Rear axle (of the vehicle)
13 Brake control subsystem
13a Superordinate control module of the brake control subsystem
13b Control unit of the brake control subsystem
13c Electrical control module, brake
15 Parking brake control device
17 Locking mechanism
19 Motor control unit
21 Electric motor
23 Brake caliper
27 Wheel
29 Service brake operating element
100 Vehicle
200 On-board power supply system
201 Vehicle control system
203 (Partially) autonomous vehicle control system
205 Driver
300 Control command
B_{P} Parking brake function
B_{B} Service brake function
B_{N} Emergency brake function
F_{B} Braking force
M_{S} Locking position of locking mechanism
M_{F} Release position of locking mechanism
q_{R} Reserve charge

1. A brake system (1) for a vehicle (100), the brake system comprising:
a plurality of electromechanical brakes (5) for braking the vehicle (100), wherein the electromechanical brakes (5) are controlled such that actuation processes for executing a parking brake function (B_{P}), a service brake function (B_{B}), and an emergency brake function (B_{N}) are executed by the brake system,
a dedicated electrical energy storage subsystem (9),
wherein the dedicated electrical energy storage system is configured for to an on-board power supply system (200) of the vehicle (100), and
wherein the dedicated electrical energy storage system stores a reserve charge (q_{R}) for at least one final actuation process for execution of the emergency brake function (B_{N}) by the brake system (1).

2. The brake system as claimed in claim 1,
wherein the energy storage subsystem (9) includes one or more electrical energy stores (9a, 9b, 9c), each of which partially or entirely carries the reserve charge (q_{R}).

3. The brake system (1) as claimed in claim 2, wherein at least one electrical energy store (9a) of the one or more electrical energy stores is assigned to at least one of a front axle (11a) or a rear axle (11b).

4. The brake system as claimed in claim 2, wherein an electrical energy store (9b) of the one or more electrical energy stores is assigned to at least one of the electromechanical brakes (5), and is integrated in the electromechanical brake (5) in each case.

5. The brake system as claimed in claim 2, wherein one or more electrical energy stores of the energy storage subsystem (9) includes at least one superordinate electrical energy store (9c) that provides energy to each of the electromechanical brakes (5).

6. The brake system (1) as claimed in claim 1, wherein the energy storage subsystem (9) delivers, additionally to the reserve charge (q_{R}), additional electrical energy for the service brake function and/or for other ancillary loads.

7. The brake system (1) as claimed in claim 1, wherein the brake system (1) includes a brake control subsystem (13), having a superordinate control module (13a) and at least one control unit (13b) for each axle (11) of the vehicle (100), wherein the brake control subsystem (13) transmits signals (S) for the actuation of electromechanical brakes (5) to at least one control unit (13b).

8. The brake system (1) as claimed in claim 7, wherein the superordinate control module (13a) monitors the parking brake function (B_{P}) of the brake system (1) for normal operation and, in the event of a critical fault, generates an emergency actuation signal (S_{N}).

9. The brake system (1) as claimed in claim 7, wherein the at least one control unit (13b) monitors the brake system for normal operation and, in the event of a critical fault, generates an emergency actuation signal (S_{N}).

10. The brake system (1) as claimed in claim 7, wherein the superordinate control module (13a) is integrated in a parking brake control device (15) for the parking brake function (B_{P})

11. The brake system (1) as claimed in claim 1, wherein the brake system (1) includes a locking mechanism (17) of each of the electromechanical brakes (5), having a locking position (M_{S}) and a release position (M_{F}), wherein the locking mechanism maintains the electromechanical brakes (5) in a locked position upon reaching a target clamping force, or in the event of an undershoot of a critical quantity of energy in the electrical energy storage subsystem (9).

12. The brake system (1) as claimed in claim 1, wherein the electromechanical brakes (5) respectively includes a respective electrical control module (13c) and a motor control unit (19).

13. The brake system (1) as claimed in claim 12, wherein the respective electrical control module (13c) receives an emergency actuation signal (S_{N}), and the motor control unit (19) converts the emergency actuation signal (S_{N}), via reserve charge (q_{R}), into a mechanical motion within the electromechanical brake (5), by which a clamping force acting on the respective wheel is generated.

14. The brake system (1) as claimed in claim 12, wherein the respective electrical control modules (13c) of the electromechanical brakes (5) execute the emergency brake function (B_{N}) in the event of the detection of a critical system state.

15. A vehicle (100), comprising:
the brake system (1) according to claim 1, and
an on-board power supply system (200) connected to the brake system (1) connected to the on-board power supply system (200).

16. A method for controlling the brake system (1) of claim 1 the method comprising:
controlling multiple electromechanical brakes (5) and executing actuation processes for the execution of a parking brake function (B_{P}), a service brake function (B_{B}) and/or an emergency brake function (B_{N}); and
storing the reserve charge (q_{R}) in the dedicated energy storage subsystem (9) of the brake system (1).

17. The method as claimed in claim 15, wherein the actuation process for executing the emergency brake function (B_{N}) employs the reserve charge (q_{R}).

18. The method as claimed in claim 16, further comprising:
providing, additionally to the reserve charge (q_{R}), additional electrical energy for the service brake function (B_{B}) and/or for other ancillary loads;
transmitting signals (S) for actuating the electromechanical brakes (5);
monitoring the parking brake function (B_{P}) of the brake system (1) for normal operation, and generating of an emergency actuation signal (S_{N}) in the event of a critical fault;
monitoring the brake system for normal operation, and generating an emergency actuation signal in the event of a critical fault (S_{N});
actuating a superordinate control module (13a) from outside of the parking brake control device (15);
maintaining the electromechanical brakes (5) in a locked position upon reaching a target clamping force or in the event of an undershoot of a critical quantity of energy in the electrical energy storage subsystem (9);
receiving an emergency actuation signal (S_{N}) by a respective electrical control module of one of the electromechanical brakes (5) and converting the emergency actuation signal (S_{N}) into a mechanical motion within the electromechanical brake (5) via the reserve charge (q_{R});
executing the emergency brake function (B_{N}).

19. The brake system (1) as claimed in claim 3, wherein at least one electrical energy store (9a) of the one or more electrical energy stores is assigned to each axle (11) of the vehicle (100).

20. The brake system (1) as claimed in claim 7, wherein the superordinate control module (13a) is controlled externally relative to a parking brake control device (15).
